(19) United States
(12) Patent Application Publication
(10) Pub. No.: US 2024/0161975 A1
(43) Pub. Date: May 16, 2024

(54) SmFeN BASED RARE EARTH MAGNET AND PRODUCTION METHOD THEREOF

(71) Applicants: NICHIA CORPORATION, Anan-shi (JP); TOYOTA JIDOSHA KABUSHIKI KAISHA, Toyota-shi (JP)

(72) Inventors: Hisashi MAEHARA, Itano-gun (JP); Tomonori INUZUKA, Toyota-shi (JP); Masaaki ITO, Anjo-shi (JP); Motoki HIRAOKA, Toyota-shi (JP)

(73) Assignees: NICHIA CORPORATION, Anan-shi (JP); TOYOTA JIDOSHA KABUSHIKI KAISHA, Toyota-shi (JP)

(21) Appl. No.: 18/506,354

(22) Filed: Nov. 10, 2023

(30) Foreign Application Priority Data
Nov. 10, 2022 (JP) 2022-180270
Oct. 5, 2023 (JP) 2023-173558

(51) Int. Cl. H01F 41/02; B22F 1/052; B22F 1/142; B22F 1/145; B22F 1/16; B22F 3/14; B22F 3/16; B22F 3/24; B22F 9/22; H01F 1/059

(52) U.S. Cl. CPC H01F 41/0266; B22F 1/052; B22F 1/142; B22F 1/145; B22F 1/16; B22F 3/14; B22F 3/16; B22F 3/24; B22F 9/22; H01F 1/059; H01F 41/0273; B22F 2003/248; B22F 2201/013; B22F 2201/02; B22F 2201/11; B22F 2202/05; B22F 2301/355; B22F 2302/45; B22F 2998/10; B22F 2999/00

(57) ABSTRACT

A method of producing a SmFeN-based rare earth magnet, the method including: heat-treating a SmFeN-based anisotropic magnetic powder having a surface coated with a phosphate at a temperature of at least 80° C. but lower than 150° C.; mixing the heat-treated SmFeN-based anisotropic magnetic powder and a Zn-containing modifier powder by dispersion using resin-coated metal media or resin-coated ceramic media to obtain a powder mixture containing the SmFeN-based anisotropic magnetic powder and the modifier powder; compacting the powder mixture in a magnetic field to obtain a magnetic field compact; and pressure-sintering the magnetic field compact to obtain a sintered compact.

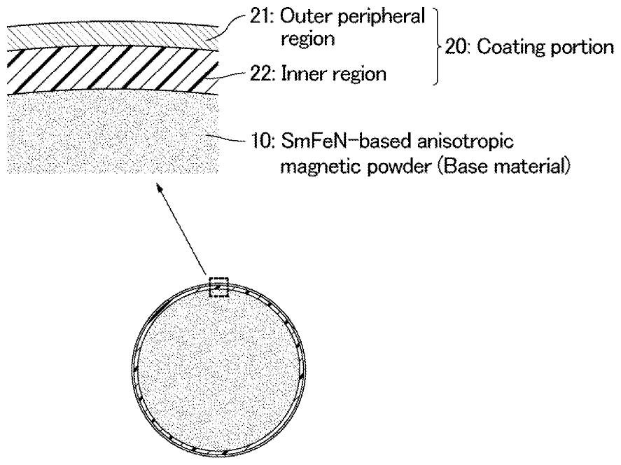

### CROSS-REFERENCE TO RELATED PATENT APPLICATION

This application claims priority to Japanese Patent Application No. 2022-180270 filed on Nov. 10, 2022 and Japanese Patent Application No. 2023-173558 filed on Oct. 5, 2023. The disclosures of Japanese Patent Application No. 2022-180270 and Japanese Patent Application No. 2023-173558 are hereby incorporated by reference in their entirety.

### BACKGROUND

The present disclosure relates to a SmFeN-based rare earth magnet and a production method thereof.

JP 2015-195326 A discloses a production method involving grinding a SmFeN-based anisotropic magnetic powder using ceramic media in a solvent. However, the use of hard ceramic media may cause chipping to form fine particles, so that the ground SmFeN-based anisotropic magnetic powder may have a higher oxygen content and lower magnetic properties.

WO 2015/199096 discloses a method of producing a SmFeN-based rare earth magnet, which includes pre-compacting a SmFeN-based anisotropic magnetic powder in a magnetic field of not lower than 6 kOe, followed by warm compaction at a temperature of not higher than 600° C. and a contact pressure of 1 to 5 GPa.

### SUMMARY

Embodiments of the present disclosure aim to provide a SmFeN-based rare earth magnet with excellent magnetic properties, and a production method thereof.

Exemplary embodiments of the present disclosure relate to a method of producing a SmFeN-based rare earth magnet, the method including: heat-treating a SmFeN-based anisotropic magnetic powder having a surface coated with a phosphate at a temperature of at least 80° C. but lower than 150° C.; mixing the heat-treated SmFeN-based anisotropic magnetic powder and a Zn-containing modifier powder by dispersion using resin-coated metal media or resin-coated ceramic media to obtain a powder mixture containing the SmFeN-based anisotropic magnetic powder and the modifier powder; compacting the powder mixture in a magnetic field to obtain a magnetic field compact; and pressure-sintering the magnetic field compact to obtain a sintered compact.

Exemplary embodiments of the present disclosure relate to a SmFeN-based rare earth magnet, including: a SmFeN-based anisotropic magnetic powder; and a coating portion coating the SmFeN-based anisotropic magnetic powder, the coating portion including an outer peripheral region in which P is localized, and an inner region located inward from the outer peripheral region, in which Zn is localized.

The embodiments of the present disclosure can provide a SmFeN-based rare earth magnet with excellent magnetic properties, and a production method thereof.

### BRIEF DESCRIPTION OF DRAWINGS

The attached FIGURE is a schematic diagram of a cross-section of the SmFeN-based anisotropic magnetic powder contained in a SmFeN-based rare earth magnet according to an embodiment of the present disclosure.

### DETAILED DESCRIPTION

Embodiments of the present disclosure are described in detail below. The following embodiments, however, are intended as examples to embody the technical idea of the present disclosure and are not intended to limit the scope of the present disclosure to the following embodiments. As used herein, the term “step” encompasses not only an independent step but also a step that may not be clearly distinguished from other steps, as long as a desired object of the step is achieved. Moreover, numerical ranges indicated using “to” refer to ranges including the numerical values before and after “to” as the minimum and maximum, respectively.

A method of producing a SmFeN-based rare earth magnet according to embodiments of the present disclosure includes:
heat-treating a SmFeN-based anisotropic magnetic powder having a surface coated with a phosphate at a temperature of at least 80° C. but lower than 150° C.;
mixing the heat-treated SmFeN-based anisotropic magnetic powder and a Zn-containing modifier powder by dispersion using resin-coated metal media or resin-coated ceramic media to obtain a powder mixture containing the SmFeN-based anisotropic magnetic powder and the modifier powder;
compacting the powder mixture in a magnetic field to obtain a magnetic field compact; and
pressure-sintering the magnetic field compact to obtain a sintered compact.

### Magnetic Powder Heat Treatment Step

In the heat treatment step, a SmFeN-based anisotropic magnetic powder having a surface coated with a phosphate may be heat-treated at a temperature of at least 80° C. but lower than 150° C. The heat treatment can be performed, for example, under a reduced pressure or vacuum after a phosphate source treatment step for coating the surface with a phosphate. The heat treatment may also be performed as a drying step during the phosphate source treatment step described later. The coercive force can be improved by not only coating with a phosphate but also chemical bonding by heat treatment. Moreover, as the heat treatment allows for chemical bonding of phosphorus, the generation of ZnO from Zn in the modifier powder can be suppressed in the step of heat-treating the SmFeN-based magnetic powder. It should be noted that, if the heat treatment temperature is lower than 80° C., moisture will remain in the SmFeN-based anisotropic magnetic powder, reducing the magnetic properties.

When the heat treatment temperature (drying temperature) after the formation of a phosphate coating is as high as 150° C. or higher, the phosphate film may cover most of the surface of the magnetic particles to improve the magnetic properties of the magnetic particles. Moreover, at higher temperatures above 150° C., the phosphate film may react to form a non-magnetic phase on the surface of the magnetic particles, thereby improving the coercive force of the magnetic particles. However, if the phosphate film excessively coats the surface of the particles, the Zn liquified during the sintering of a sintered magnet produced with Zn as a binder cannot sufficiently diffuse into the magnetic powder, and therefore a fluidized bed may be less likely to be formed during the sintering. Without the formation of a fluidized bed, excessive pressure may be applied to the magnetic particles during the sintering, which can cause cracking of the magnetic particles or distortion of the crystal structure, resulting in lower magnetic properties. In the present embodiments, the heat treatment at lower than 150° C. can prevent the phosphate film from excessively coating most of the surface of the magnetic powder particles, thereby improving the remanence Br and coercive force iHc of the sintered SmFeN-based rare earth magnet. Although the heat treatment temperature is at least 80° C. but lower than 150° C., it is preferably higher than 100° C. but lower than 150° C., more preferably higher than 100° C. but not higher than 130° C. At such preferable temperatures, the remanence Br and coercive force iHc of the resulting SmFeN-based rare earth magnet can be further improved.

The SmFeN-based anisotropic magnetic powder may contain SmFeN, SmFeLaN, SmFeLaWN, or SmFeLaWRN where R is at least one selected from the group consisting of Ti, Ba, and Sr. The magnetic powder used may be a mixture of a SmFeLaWN-containing anisotropic magnetic powder and a SmFeLaWTiN-containing anisotropic magnetic powder. When a powder mixture is used which contains different particle groups, such as a first particle group and a second particle group as described later, a R-containing SmFeN-based anisotropic magnetic powder is preferably used as a particle group mixed at a high ratio because the R-containing SmFeN-based anisotropic magnetic powder has excellent magnetic properties. It should be noted that the SmFeN-based anisotropic magnetic powder having a surface coated with a phosphate is not limited to a SmFeN-based anisotropic magnetic powder whose entire surface is completely coated with a phosphate film and may be one in which a phosphate film is formed on at least part of the surface.

### Modifier Powder Mixing Step

In the mixing step, the dispersed SmFeN-based anisotropic magnetic powder and a modifier powder may be mixed to obtain a powder mixture. Examples of the modifier powder include zinc and zinc alloys. In view of residual magnetization, the upper limit of the amount of the modifier powder relative to the amount of the SmFeN-based anisotropic magnetic powder is, for example, preferably not more than 15% by mass, more preferably not more than 10% by mass, still more preferably not more than 7% by mass. The lower limit may be not less than 1% by mass, for example.

When a zinc alloy is represented by Zn-M², M² may be selected from elements which can be alloyed with Zn (zinc) to lower the melting onset temperature of the zinc alloy below the melting point of Zn, and unavoidable impurity elements. In this case, improved sinterability can be obtained in the pressure-sintering step described later. Examples of M² capable of lowering the melting point below that of Zn include elements capable of forming M²—Zn eutectic alloys. Typical examples of such M² elements include Sn, Mg, and Al, and combinations thereof, where Sn represents tin, Mg represents magnesium, and Al represents aluminum. M² may also be selected from elements which do not inhibit the melting point-lowering function of these elements and the properties of the product. Moreover, the term “unavoidable impurity elements” refers to impurity elements which are inevitably contained, such as impurities contained in the raw materials of the modifier powder, or the avoidance of which leads to a significant increase in production cost.

In the zinc alloy represented by Zn-M², the ratio (molar ratio) between Zn and M² may be appropriately set to give an appropriate sintering temperature. For example, the ratio (molar ratio) of M² to the total zinc alloy may be not lower than 0.05, not lower than 0.10, or not lower than 0.20, but may be not higher than 0.90, not higher than 0.80, not higher than 0.70, not higher than 0.60, not higher than 0.50, not higher than 0.40, or not higher than 0.30.

The particle size D₅₀ (median size) of the modifier powder is not limited, and may be not less than 0.1 μm, not less than 0.5 μm, not less than 1 μm, or not less than 2 μm, but may be not more than 12 μm, not more than 11 μm, not more than 10 μm, not more than 9 μm, not more than 8 μm, not more than 7 μm, not more than 6 μm, not more than 5 μm, or not more than 4 μm. Herein, the term “D₅₀” refers to the particle size corresponding to 50% of the cumulative particle size distribution by volume of the modifier powder. The D₅₀ can be measured by a dry laser diffraction/scattering method.

The modifier powder preferably has a low oxygen content to absorb much oxygen from the SmFeN-based magnetic powder. The oxygen content of the modifier powder is preferably not more than 5.0% by mass, more preferably not more than 3.0% by mass, still more preferably not more than 1.0% by mass of the total modifier powder. However, extremely reducing the oxygen content of the modifier powder leads to an increase in production cost. From this point of view, the oxygen content of the modifier powder may be not less than 0.1% by mass, not less than 0.2% by mass, or not less than 0.3% by mass of the total modifier powder.

In the mixing step, the SmFeN-based anisotropic magnetic powder having a surface coated with a phosphate heat-treated in the heat treatment step and a Zn-containing modifier powder may be dispersed using resin-coated metal media or resin-coated ceramic media. In the mixing step, either of mixing or dispersing of the SmFeN-based anisotropic magnetic powder and the modifier powder may be performed first or alternatively both may be performed simultaneously. For example, before mixing the SmFeN-based anisotropic magnetic powder and the modifier powder, they may be introduced and dispersed in a dispersion apparatus to perform mixing and dispersion simultaneously. Herein, the term “dispersion”, “dispersing”, or “dispersed” means that the aggregated particles in the SmFeN-based anisotropic magnetic powder formed by sintering, magnetic aggregation, etc. are separated into single particles or particles consisting of very few particles. Since the impact energy of the collision between the SmFeN-based anisotropic magnetic powder and the resin-coated metal media or resin-coated ceramic media is smaller than that between the SmFeN-based anisotropic magnetic powder and non-resin coated metal media or non-resin coated ceramic media, dispersion is more likely to occur than grinding. If the SmFeN-based anisotropic magnetic powder is ground as in the conventional art, the fine particles formed due to chipping may be oxidatively degraded, thereby reducing the magnetic properties of the SmFeN-based anisotropic magnetic powder. It is also considered that when the SmFeN-based anisotropic magnetic powder containing fine particles is used to produce a SmFeN-based rare earth magnet, the fine particles may not be sufficiently oriented during compaction in a magnetic field, resulting in a decrease in the magnetic properties of the SmFeN-based rare earth magnet. In contrast, when the SmFeN-based anisotropic magnetic powder is dispersed as in the present embodiments, the resulting SmFeN-based anisotropic magnetic powder contains only a small number of fine particles and aggregated particles. Thus, it is considered possible to reduce the decrease in the magnetic properties of the SmFeN-based anisotropic magnetic powder due to oxidative degradation of fine particles. It is also considered that this SmFeN-based anisotropic magnetic powder can be sufficiently oriented even during compaction in a magnetic field, so that the resulting SmFeN-based rare earth magnet is likely to have high magnetic properties. The dispersion using resin-coated metal media or resin-coated ceramic media can reduce separation or damage of the phosphate coating portion on the surface of the SmFeN-based anisotropic magnetic powder.

Examples of the dispersion apparatus used for dispersion include vibration mills. The media used in the dispersion apparatus such as vibration mill may include a metal core and a resin coating the metal core. In certain embodiments, the resin-coated metal media or the resin-coated ceramic media may be separated from the SmFeN-based anisotropic magnetic powder and/or the modifier powder after the dispersion. Examples of the metal material include iron, chromium steel, stainless steel, and steel. The media used in the dispersion apparatus such as vibration mill may also include a ceramic core and a resin coating the ceramic core. Examples of the ceramic material include inorganic compounds such as oxides, carbides, nitrides, or borides of metals or non-metals. Specific examples include alumina, silica, zirconia, silicon carbide, silicon nitride, barium titanate, and glass. Iron or chromium steel is preferred among these because they have a high dispersing ability owing to the high specific gravity and less wear owing to the high hardness, and also because the iron-containing wear powder generated by abrasion has a low impact on the SmFeN-based anisotropic magnetic powder. In other words, resin-coated iron media or resin-coated chromium steel media are preferably used in the dispersion apparatus. Examples of the coating resin include thermoplastic resins such as nylon 6, nylon 66, nylon 12, polypropylene, polyphenylene sulfide, and polyethylene, and thermosetting resins such as epoxy resins and silicone resins. Since thermoplastic resins can be subjected to injection molding to form a coating layer, and they have a higher fluidity than thermosetting resins, the coating film formed from a thermoplastic resin can be thinner than that formed from a thermosetting resin. Therefore, thermoplastic resin-coated media can have a higher specific gravity and a smaller size than those of thermosetting resin-coated media. Nylon such as nylon 6, nylon 66, or nylon 12 is preferred among the thermoplastic resins, because nylon is relatively soft and inexpensive among the thermoplastic resins. For example, nylon-coated iron media may be used in the dispersion apparatus. In this case, the SmFeN-based anisotropic magnetic powder can be dispersed while further reducing the generation of fine particles.

When a vibration mill is used for dispersion, for example, the amount of the media may be at least 60% by volume but not more than 70% by volume, and the amount of the SmFeN-based anisotropic magnetic powder may be at least 3% by volume but not more than 20% by volume, preferably at least 5% by volume but not more than 20% by volume, each relative to the volume of the container used to contain the SmFeN-based anisotropic magnetic powder and the media.

The specific gravity of the media used for dispersion is preferably at least 4, more preferably at least 5. If the specific gravity is less than 4, the impact energy during dispersion tends to be too small so that dispersion is less likely to occur. The upper limit of the specific gravity is not limited but is preferably not more than 8, more preferably not more than 7.5. The specific gravity of the media used for dispersion may be at least 6 but not more than 7.5. The resin-coated metal media or resin-coated ceramic media may include a metal or ceramic core and a resin film coating the core. For example, the thickness of the resin film may be at least 0.1 μm but not more than 5 mm. This can reduce an increase in the diameter of the media and thus is suitable for dispersing the SmFeN-based anisotropic magnetic powder, and the resulting SmFeN-based anisotropic magnetic powder can have an improved residual magnetization Gr.

The diameter of the media is preferably at least 2 mm but not more than 100 mm, more preferably at least 3 mm but not more than 15 mm, still more preferably at least 3 mm but not more than 10 mm. The media having a diameter of less than 2 mm may be difficult to coat with a resin, while the media having a diameter of more than 100 mm are large and thus tend to have less contact with the powder so that dispersion is less likely to occur.

Although the dispersion may be performed in a wet condition (in the presence of a liquid dispersion medium), it is preferably performed in a dry condition (in the absence of a liquid dispersion medium) to inhibit the oxidation of the SmFeN-based anisotropic magnetic powder due to the components such as moisture in the dispersion medium.

To inhibit oxidation of the SmFeN-based anisotropic magnetic powder, the dispersion is preferably performed in an inert gas atmosphere such as a nitrogen gas atmosphere or an argon gas atmosphere. The concentration of nitrogen in the nitrogen gas atmosphere may be 90% by volume or more, preferably 95% by volume or more. The concentration of argon in the argon gas atmosphere may be 90% by volume or more, preferably 95% by volume or more. The inert gas atmosphere may be an atmosphere in which two or more inert gases such as nitrogen gas and argon gas are mixed. The concentration of the inert gas(es) in the inert gas atmosphere may be 90% by volume or more, preferably 95% by volume or more.

The average particle size of the dispersed SmFeN-based anisotropic magnetic powder is not limited, and it is preferably at least 2.5 μm but not more than 5 μm, more preferably at least 2.6 μm but not more than 4.5 μm. The SmFeN-based anisotropic magnetic powder having an average particle size of less than 2.5 μm has a large surface area and is thus more likely to be oxidized. The SmFeN-based anisotropic magnetic powder having an average particle size of more than 5 μm tends to have a multidomain structure, resulting in lower magnetic properties. Herein, the term “average particle size” refers to the particle size measured using a laser diffraction particle size distribution analyzer under a dry condition.

The particle size D₁₀ of the dispersed SmFeN-based anisotropic magnetic powder is preferably at least 0.5 μm but not more than 3 μm, more preferably at least 1 μm but not more than 2 μm. If the D₁₀ is less than 0.5 μm, the amount of the SmFeN-based anisotropic magnetic powder charged in the magnet tends to be reduced, resulting in lower magnetization. Conversely, if the D₁₀ is more than 3 μm, the coercive force of the magnet tends to decrease. Herein, the term “D₁₀” refers to the particle size corresponding to 10% of the cumulative particle size distribution by volume of the SmFeN-based anisotropic magnetic powder.

The particle size D₅₀ of the dispersed SmFeN-based anisotropic magnetic powder is preferably at least 2 μm but not more than 5 μm, more preferably at least 2.5 μm but not more than 4.5 μm. If the D₅₀ is less than 2 μm, the amount of the SmFeN-based anisotropic magnetic powder charged in the magnet tends to be reduced, resulting in lower magnetization. If the D₅₀ is more than 5 μm, the coercive force of the magnet tends to decrease. Herein, the term “D₅₀” refers to the particle size corresponding to 50% of the cumulative particle size distribution by volume of the SmFeN-based anisotropic magnetic powder.

The particle size D₉₀ of the dispersed SmFeN-based anisotropic magnetic powder is preferably at least 3 μm but not more than 7 μm, more preferably at least 4.5 μm but not more than 6.5 μm. If the D₉₀ is less than 3 μm, the amount of the SmFeN-based anisotropic magnetic powder charged in the magnet tends to be reduced, resulting in lower magnetization. If the D₉₀ is more than 7 μm, the coercive force of the magnet tends to decrease. Herein, the term “D₉₀” refers to the particle size corresponding to 90% of the cumulative particle size distribution by volume of the SmFeN-based anisotropic magnetic powder.

Preferably, the heat-treated SmFeN-based anisotropic magnetic powder includes a first particle group and a second particle group, and the first particle group has a particle size D₅₀ at 50% of the cumulative particle size distribution by volume that is larger than that of the second particle group. The inclusion of the first particle group and the second particle group can improve the density of the SmFeN-based rare earth magnet to be obtained. The D₅₀ of the first particle group is more preferably at least 1.5 times larger than the D₅₀ of the second particle group. Herein, the particle sizes D₅₀ of the first particle group and the second particle group refer to the particle sizes D₅₀ of the first particle group and the second particle group, respectively, before they are mixed. For example, the SmFeN-based anisotropic magnetic powder including the first particle group and the second particle group may be obtained, for example, by mixing two types of magnetic powders having different particle sizes and then dispersing them, or by separately dispersing two types of magnetic powders having different particle sizes and then mixing them. The above-described preferred numerical ranges of the particle sizes D₁₀, D₅₀, and D₉₀ of the dispersed SmFeN-based anisotropic magnetic powder may be used as the preferred numerical ranges for a mixture of multiple particle groups such as the first particle group and the second particle group.

The amount of the first particle group in the SmFeN-based anisotropic magnetic powder including the first particle group and the second particle group is preferably at least 75% by mass but not more than 95% by mass, preferably at least 80% by mass but not more than 90% by mass. Since the second particle group tends to have a lower magnetization than the first particle group, less than 75% by mass of the first particle group tends to result in a decrease in the magnetization of the sintered magnet. More than 95% by mass of the first particle group tends to result in a decrease in the density of the sintered magnet.

When mixing is performed separately from dispersion, it may be carried out by any method, such as using a mortar, a muller wheel mixer, an agitator mixer, a mechano-fusion system, a V-mixer, or a ball mill. These methods may be combined. Here, the term “V-mixer” refers to an apparatus equipped with two cylindrical vessels connected in a V shape in which the vessels may be rotated to repeatedly gather and separate powder particles in the vessels by gravity and centrifugal force, thereby mixing them.

### Compaction Step

In the compaction step, the powder mixture may be compacted in a magnetic field to obtain a magnetic field compact. The magnetic field orientation can impart orientation to the magnetic field compact and thus can impart anisotropy to the SmFeN-based rare earth magnet to improve the residual magnetization. The magnetic field compaction may be performed by known methods, such as compacting the powder mixture using a compacting die and a magnetic field generator located around the die. The compacting pressure may be not less than 10 MPa, not less than 20 MPa, not less than 30 MPa, not less than 50 MPa, not less than 100 MPa, or not less than 150 MPa, but may be not more than 1,500 MPa, not more than 1,000 MPa, or not more than 500 MPa. The magnitude of the magnetic field to be applied may be not less than 500 kA/m, not less than 1,000 kA/m, not less than 1,500 kA/m, or not less than 1,600 kA/m, but may be not more than 20,000 kA/m, not more than 15,000 kA/m, not more than 10,000 kA/m, not more than 5,000 kA/m, not more than 3,000 kA/m, or not more than 2,000 kA/m. The application of the magnetic field may be performed, for example, by applying a static magnetic field using an electromagnet or by applying an alternating pulsed magnetic field.

### Sintering Step

In the pressure-sintering step, the magnetic field compact may be pressure-sintered to obtain a sintered compact. The sintered compact may be directly used as a SmFeN-based rare earth magnet. The pressure-sintering may be performed by any method, such as by providing a die having a cavity and a punch capable of sliding within the cavity, inserting the magnetic field compact into the cavity, and sintering the magnetic field compact while applying a pressure to the magnetic field compact using the punch. For example, spark plasma sintering (SPS) may be used as the pressure-sintering method. The pressure-sintering conditions may be appropriately selected to be able to sinter the magnetic field compact while applying a pressure to the magnetic field compact (hereinafter, also referred to as “pressure-sinter”). When the sintering temperature is not lower than 300° C., the Fe in the surface of the SmFeN-based anisotropic magnetic powder particles and the modifier powder (for example, metallic zinc) can be slightly interdiffused in the magnetic field compact, thereby contributing to sintering. For example, the sintering temperature may be not lower than 310° C., not lower than 320° C., not lower than 340° C., or not lower than 350° C. Moreover, when the sintering temperature is not higher than 400° C., excessive interdiffusion can be suppressed between the Fe in the surface of the SmFeN-based anisotropic magnetic powder particles and the modifier powder. This can reduce difficulties in the heat treatment step described later and adverse effects on the magnetic properties of the resulting sintered compact. From these standpoints, the sintering temperature may be not higher than 400° C., not higher than 390° C., not higher than 380° C., or not higher than 370° C. In the present embodiments, the heat treatment of the SmFeN-based anisotropic magnetic powder having a surface coated with a phosphate at lower than 150° C. can inhibit the phosphate film from excessively coating most of the surface of the magnetic powder particles. This is considered to lead to moderate interdiffusion between the Fe in the surface of the SmFeN-based anisotropic magnetic powder particles and the modifier powder (for example, metallic zinc) during the sintering step.

The sintering pressure may be appropriately selected from those which can increase the density of the sintered compact. The sintering pressure may typically be not less than 100 MPa, not less than 200 MPa, not less than 400 MPa, or not less than 600 MPa, but may be not more than 2,000 MPa, not more than 1,800 MPa, not more than 1,600 MPa, not more than 1,500 MPa, not more than 1,300 MPa, or not more than 1,200 MPa.

The sintering duration may be appropriately set so that the Fe in the surface of the SmFeN-based anisotropic magnetic powder particles and the metallic zinc of the modifier powder can be slightly interdiffused. Here, the sintering duration excludes the time required to increase the temperature to the heat treatment temperature. For example, the sintering duration may be not shorter than 1 minute, not shorter than 2 minutes, or not shorter than 3 minutes, but may be not longer than 90 minutes, not longer than 60 minutes, or not longer than 30 minutes. The sintering duration may also be not longer than 20 minutes, not longer than 10 minutes, or not longer than 5 minutes.

Once the sintering duration has elapsed, the sintered compact may be cooled to terminate the sintering. A faster cooling rate can more inhibit oxidation or other reaction of the sintered compact. For example, the cooling rate may be at least 0.5° C./sec but not more than 200° C./sec. The sintering atmosphere is preferably an inert gas atmosphere in order to inhibit oxidation of the magnetic field compact or the sintered compact. Examples of the inert gas atmosphere include a nitrogen gas atmosphere.

The method of producing a SmFeN-based rare earth magnet according to the present embodiments preferably further includes heat-treating the sintered compact to obtain a SmFeN-based rare earth magnet.

### Sintered Compact Heat Treatment Step

In the sintered compact heat treatment step, the SmFeN-based rare earth magnet obtained by sintering may be heat-treated. The heat treatment can cause the particles of the SmFeN-based anisotropic magnetic powder to form a Fe—Zn alloy phase as a coating on the particle surface to further strongly bind (hereinafter, also referred to as “solidify”) the particles of the SmFeN-based anisotropic magnetic powder to the particles of the modifier powder while simultaneously promoting modification. At a heat treatment temperature of not lower than 350° C., the Fe—Zn alloy phase can be appropriately formed on almost all the particles, ensuring solidification and modification. The heat treatment temperature may be not lower than 360° C., not lower than 370° C., or not lower than 380° C.

The magnetic phase of the SmFeN-based anisotropic magnetic powder may have a Th₂Zn₁₇ type and/or Th₂Ni₁₇ type crystalline structure, and the formation of the Fe—Zn alloy phase may saturate when the heat treatment duration reaches 40 hours. In view of economic efficiency (time reduction), the heat treatment duration is preferably not longer than 40 hours, not longer than 35 hours, not longer than 30 hours, not longer than 25 hours, or not longer than 24 hours. To inhibit oxidation of the sintered compact, the sintered compact is preferably heat-treated under vacuum or in an inert gas atmosphere. Here, examples of the inert gas atmosphere include a nitrogen gas atmosphere. The sintered compact may be heat-treated in the die used in the pressure-sintering, but no pressure is applied to the sintered compact during the heat treatment. In this case, as long as the above-mentioned heat treatment conditions are satisfied, normal magnetic phase and Fe—Zn alloy phase can be appropriately formed, without excessive interdiffusion between Fe and Zn.

The method of producing a SmFeN-based rare earth magnet according to the present embodiments preferably further includes, before the magnetic powder heat treatment step, acid-treating the SmFeN-based anisotropic magnetic powder to be used in the magnetic powder heat treatment step with an acid, and phosphate source-treating the acid-treated SmFeN-based anisotropic magnetic powder with a phosphate source to obtain the SmFeN-based anisotropic magnetic powder having a surface coated with a phosphate.

### Acid Treatment Step

In the acid treatment step, the Sm-rich layer of the SmFeN-based anisotropic magnetic powder to be used in the magnetic powder heat treatment step may be at least partially removed to reduce the oxygen concentration of the total magnetic powder. Moreover, when the SmFeN-based anisotropic magnetic powder is prepared without grinding, the SmFeN-based anisotropic magnetic powder has a small average particle size and a narrow particle size distribution and also does not contain fine particles formed by grinding, which makes it possible to reduce an increase in oxygen concentration.

Examples of the acid used in the acid treatment step include hydrogen chloride, nitric acid, sulfuric acid, and acetic acid. To avoid residual impurities, hydrogen chloride or nitric acid is preferred among these.

The amount of the acid used in the acid treatment step per 100 parts by mass of the SmFeN-based anisotropic magnetic powder is preferably at least 3.5 parts by mass but not more than 13.5 parts by mass, more preferably at least 4 parts by mass but not more than 10 parts by mass. If the amount is less than 3.5 parts by mass, an oxide tends to remain on the surface of the SmFeN-based anisotropic magnetic powder to increase the oxygen concentration. If the amount is more than 13.5 parts by mass, reoxidation is more likely to occur upon exposure to the air. In addition, the acid can dissolve the SmFeN-based anisotropic magnetic powder and the cost also tends to increase. When the amount of the acid is at least 3.5 parts by mass but not more than 13.5 parts by mass per 100 parts by mass of the SmFeN-based anisotropic magnetic powder, the surface of the SmFeN-based anisotropic magnetic powder can be covered with the Sm-rich layer oxidized enough to inhibit reoxidation upon exposure to the air after the acid treatment. Thus, the resulting SmFeN-based anisotropic magnetic powder has a low oxygen concentration, a small average particle size, and a narrow particle size distribution.

The acid treatment may be performed while stirring the slurry containing the SmFeN-based anisotropic magnetic powder. In the acid treatment step, the SmFeN-based anisotropic magnetic powder obtained after the acid treatment may optionally be subjected to decantation or other techniques to reduce the moisture.

### Phosphate Source Treatment Step

The magnetic powder heat treatment step may be preceded by treating the anisotropic magnetic powder with a phosphate source. When the acid treatment step is performed, the phosphate source treatment step is performed after the acid treatment step. The SmFeN-based anisotropic magnetic powder treated with a phosphate source is provided with a passive film having a P—O bond on the surface of the magnetic powder. The coating of the magnetic powder with a film containing P and O can reduce oxidative degradation due to the air during processing.

In the phosphate source treatment step, the SmFeN-based anisotropic magnetic powder may be treated with a phosphate source. Examples of the phosphate source include orthophosphoric acid, sodium dihydrogen phosphate, potassium dihydrogen phosphate, ammonium dihydrogen phosphate, diammonium hydrogen phosphate, zinc phosphate, calcium phosphate, and other phosphates, hypophosphorous acid and hypophosphites, pyrophosphoric acid, polyphosphoric acid, and other inorganic phosphoric acids, and organic phosphoric acids, and salts thereof. Such a phosphate source may basically be dissolved in water or an organic solvent such as IPA, optionally supplemented with a reaction accelerator such as nitrate ions or a grain refiner such as V ions, Cr ions, or Mo ions, and the magnetic powder may be introduced into the resulting phosphate bath to form a passive film having a P—O bond on the surface of the anisotropic magnetic powder. The phosphate source is preferably dissolved in water, which can reduce the carbon content of the SmFeN-based anisotropic magnetic powder as compared to when dissolved in an organic solvent. Thus, the portion coated with the phosphate is unlikely to have defects derived from carbon-containing organic impurities, and a decrease in the coercive force of the SmFeN-based anisotropic magnetic powder can be reduced. For the same reason, the phosphate source is also preferably an inorganic phosphoric acid. The phosphate source treatment may be performed while stirring the slurry containing the SmFeN-based anisotropic magnetic powder.

The SmFeN-based anisotropic magnetic powder of the SmFeN-based anisotropic magnetic powder having a surface coated with a phosphate used in the magnetic powder heat treatment step preferably contains not only Sm, Fe but also La, W and may further contain R which is at least one selected from the group consisting of Ti, Ba, and Sr. Such a magnetic powder can be prepared with reference to the method disclosed in, for example, JP 2017-117937 A or JP 2021-055188 A. An exemplary method of producing the SmFeN-based anisotropic magnetic powder will be described below.

The undispersed SmFeN-based anisotropic magnetic powder used in the magnetic powder heat treatment step may be prepared by a production method including: pretreating an oxide containing Sm and Fe by heat treatment in a reducing gas-containing atmosphere to obtain a partial oxide; heat-treating the partial oxide in the presence of a reducing agent to obtain alloy particles; nitriding the alloy particles to obtain a nitride; and washing the nitride to obtain a SmFeN-based anisotropic magnetic powder. A SmFeN-based anisotropic magnetic powder can be obtained through these steps without grinding. Moreover, the obtained SmFeN-based anisotropic magnetic powder does not need to be ground in subsequent steps. The nitridation step may be followed by post-treating the nitride obtained in the nitridation step or by treating the nitride obtained in the nitridation step with an alkali. Preferably, the oxide further contains La, W, and R which is at least one selected from the group consisting of Ti, Ba, and Sr.

The oxide containing Sm and Fe used in the pretreatment step may be prepared by mixing a Sm oxide and a Fe oxide. The oxide can also be produced by mixing a solution containing Sm and Fe with a precipitant to obtain a precipitate containing Sm and Fe (precipitation step), and calcining the precipitate to obtain an oxide containing Sm and Fe (oxidation step).

### Precipitation Step

In the precipitation step, a Sm raw material and a Fe raw material may be dissolved in a strong acid solution to prepare a solution containing Sm and Fe. When the main phase to be obtained is Sm₂Fe₁₇N₃, the molar ratio of Sm and Fe (Sm:Fe) is preferably 1.5:17 to 3.0:17, more preferably 2.0:17 to 2.5:17. To the solution may be added a raw material such as La, W, Co, Ti, Sc, Y, Pr, Nd, Pm, Gd, Tb, Dy, Ho, Er, Tm, Lu, Ba, or Sr. In view of remanence, the solution preferably contains La. In view of coercive force and squareness ratio, the solution preferably contains W. In view of temperature characteristics, the solution preferably contains Co, Ti. Particularly preferably, the solution contains La, W and may further contain R which is at least one selected from the group consisting of Ti, Ba, and Sr.

Any Sm raw material or Fe raw material soluble in a strong acid solution may be used. In view of availability, examples of the Sm raw material include samarium oxide, and examples of the Fe raw material include FeSO₄. The concentration of the solution containing Sm and Fe may be appropriately adjusted within a range in which the Sm raw material and the Fe raw material can be substantially dissolved in the acid solution. In view of solubility, examples of the acid solution include sulfuric acid.

The solution containing Sm and Fe may be reacted with a precipitant to obtain an insoluble precipitate containing Sm and Fe. Here, the solution containing Sm and Fe is not limited as long as Sm and Fe are present in the solution during the reaction with the precipitant. For example, a solution of a Sm raw material and a solution of a Fe raw material may be separately prepared and individually added dropwise to react with a precipitant. When separate solutions are prepared, they may be appropriately adjusted within a range in which the respective raw materials can be substantially dissolved in the acid solution. The precipitant may be any alkaline solution that can react with a solution containing Sm and Fe to give a precipitate. Examples include ammonia water and caustic soda, with caustic soda being preferred.

To easily control the particle properties of the precipitate, the precipitation reaction is preferably performed by dropwise adding the solution containing Sm and Fe and the precipitant each to a solvent such as water. A precipitate having a homogeneous element distribution, a narrow particle size distribution, and a uniform particle shape can be obtained by appropriately controlling the feeding rates of the solution containing Sm and Fe and the precipitant, the reaction temperature, the concentration of the reaction solution, the pH during the reaction, and other conditions. The use of such a precipitate improves the magnetic properties of the finally produced SmFeN-based anisotropic magnetic powder. The reaction temperature is preferably at least 0° C. but not higher than 50° C., more preferably at least 35° C. but not higher than 45° C. The concentration of the reaction solution calculated as the total concentration of metal ions is preferably at least 0.65 mol/L but not more than 0.85 mol/L, more preferably at least 0.7 mol/L but not more than 0.85 mol/L. The reaction pH is preferably at least 5 but not more than 9, more preferably at least 6.5 but not more than 8.

In view of magnetic properties, the solution containing Sm and Fe preferably further contains at least one metal selected from the group consisting of La, W, and R which is at least one selected from the group consisting of Ti, Ba, and Sr. For example, in view of remanence, the solution preferably contains La. In view of coercive force and squareness ratio, the solution preferably contains W. In view of temperature characteristics, the solution preferably contains Ti and more preferably contains La, W, and R. Any La raw material soluble in a strong acid solution may be used. In view of availability, examples include La₂O₃ and LaCl₃. The concentration may be appropriately adjusted within a range in which the Sm raw material and the Fe raw material as well as the La raw material, the W raw material, the Ti raw material can be substantially dissolved in the acid solution. In view of solubility, examples of the acid solution include sulfuric acid. Examples of the W raw material include ammonium tungstate; examples of the Ti raw material include sulfated titania; examples of the Ba raw material include barium carbonate; and examples of the Sr raw material include strontium carbonate.

When the solution containing Sm and Fe further contains at least one metal selected from the group consisting of La, W, and R which is at least one selected from the group consisting of Ti, Ba, and Sr, an insoluble precipitate will be produced containing Sm, Fe, and at least one selected from the group consisting of La, W, and R which is at least one selected from the group consisting of Ti, Ba, and Sr. Here, the solution is not limited as long as the solution contains at least one selected from the group consisting of La, W, and R which is at least one selected from the group consisting of Ti, Ba, and Sr during the reaction with the precipitant. For example, solutions of the respective raw materials may be separately prepared and individually added dropwise to react with the precipitant. Alternatively, they may be prepared into the same solution containing Sm and Fe.

The powder obtained in the precipitation step roughly determines the powder particle size, particle shape, and particle size distribution of the finally produced SmFeN-based anisotropic magnetic powder. When the particle size of the obtained powder is measured with a laser diffraction-type wet particle size distribution analyzer, the size and distribution of all the powder may preferably substantially fall within the range of at least 0.05 μm but not more than 20 μm, preferably at least 0.1 μm but not more than 10 μm.

After separating the precipitate, the separated precipitate is preferably subjected to solvent removal in order to reduce aggregation of the precipitate caused by evaporation of the residual solvent in which the precipitate has been re-dissolved during the heat treatment in the subsequent oxidation step, and to reduce changes in properties such as particle size distribution and powder particle size. Specifically, for example, when the solvent used is water, the solvent removal may be performed by drying in an oven at a temperature of at least 70° C. but not higher than 200° C. for at least 5 hours but not longer than 12 hours.

The precipitation step may be followed by separating and washing the resulting precipitate. The washing step may be appropriately performed until the conductivity of the supernatant solution reaches 5 mS/m 2 or lower. The step of separating the precipitate may be performed, for example, by mixing the resulting precipitate with a solvent, preferably water, and then subjecting the mixture to filtration, decantation, or other separation methods.

### Oxidation Step

The oxidation step includes calcining the precipitate formed in the precipitation step to obtain an oxide containing Sm and Fe. For example, the precipitate may be converted into an oxide by heat treatment. The heat treatment of the precipitate needs to be performed in the presence of oxygen, for example in an air atmosphere. Moreover, since the presence of oxygen is necessary, the non-metal portion of the precipitate preferably contains an oxygen atom.

The heat treatment temperature in the oxidation step (hereinafter, oxidation temperature) is not limited, but it is preferably at least 700° C. but not higher than 1300° C., more preferably at least 900° C. but not higher than 1200° C. If the temperature is lower than 700° C., the oxidation tends to be insufficient. If the temperature is higher than 1300° C., the resulting SmFeN-based anisotropic magnetic powder tends not to have the target particle shape, average particle size, and particle size distribution. The heat treatment duration is also not limited, but it is preferably at least one hour but not longer than three hours.

The thus formed oxide is oxide particles in which Sm and Fe have been microscopically sufficiently mixed, and the shape, particle size distribution, and other properties of the precipitate have been reflected.

### Pretreatment Step

The pretreatment step includes heat-treating the oxide containing Sm and Fe in a reducing gas-containing atmosphere to obtain a partial oxide which is a partially reduced oxide. The concentration of the reducing gas in the reducing gas-containing atmosphere may be at least 90 vol %, preferably at least 95 vol %.

Herein, the term “partial oxide” refers to a partially reduced oxide. The oxygen concentration of the partial oxide is not limited, but is preferably not more than 10% by mass, more preferably not more than 8% by mass. If the concentration is more than 10% by mass, the heat generated by reduction with Ca in the reduction step tends to increase, raising the calcination temperature and thus forming abnormally grown particles. Herein, the oxygen concentration of the partial oxide can be measured by non-dispersive infrared spectroscopy (ND-IR).

The reducing gas may be appropriately selected from, for example, hydrogen (H₂), carbon monoxide (CO), hydrocarbon gases such as methane (CH₄), and combinations thereof. Hydrogen gas is preferred in terms of cost. The flow rate of the gas may be appropriately adjusted within a range that does not cause scattering of the oxide. The heat treatment temperature in the pretreatment step (hereinafter, pretreatment temperature) is preferably at least 300° C. but not higher than 950° C. The lower limit is more preferably at least 400° C., still more preferably at least 750° C. The upper limit is more preferably lower than 900° C. When the pretreatment temperature is at least 300° C., the oxide containing Sm and Fe can be efficiently reduced. When the pretreatment temperature is not higher than 950° C., the grain growth and segregation of the oxide particles can be inhibited so that the desired particle size can be maintained. The heat treatment duration is not limited, but may be at least one hour but not longer than 50 hours. Moreover, when the reducing gas used is hydrogen, preferably, the thickness of the oxide layer used is adjusted to not more than 20 mm, and further the dew point in the reaction furnace is adjusted to not higher than −10° C.

### Reduction Step

The reduction step includes heat-treating the partial oxide in the presence of a reducing agent to obtain alloy particles. For example, the reduction may be performed by contacting the partial oxide with molten calcium or calcium vapor. In view of magnetic properties, the heat treatment temperature is preferably at least 920° C. but not higher than 1200° C., more preferably at least 950° C. but not higher than 1150° C., still more preferably at least 980° C. but not higher than 1100° C.

As an alternative to the above-mentioned heat treatment in the reduction step, heat treatment may be performed at a first temperature of at least 1000° C. but not higher than 1090° C. and then at a second temperature lower than the first temperature of at least 980° C. but not higher than 1070° C. The first temperature is preferably at least 1010° C. but not higher than 1080° C., and the second temperature is preferably at least 990° C. but not higher than 1060° C. With regard to the difference between the first temperature and the second temperature, the second temperature is preferably lower than the first temperature by at least 15° C. but not more than 60° C., more preferably by at least 15° C. but not more than 30° C. The heat treatment at the first temperature and the heat treatment at the second temperature may be continuously performed. Although between these heat treatments there may be a heat treatment at a temperature lower than the second temperature, it is preferred in view of productivity to perform these heat treatments continuously. To perform a more uniform reduction reaction, the duration of each heat treatment is preferably shorter than 120 minutes, more preferably shorter than 90 minutes. The lower limit of the heat treatment duration is preferably not shorter than 10 minutes, more preferably not shorter than 30 minutes.

As the reducing agent, metallic calcium may be used in the form of granules or powder, and its average particle size is preferably not more than 10 mm. This can more effectively reduce aggregation during the reduction reaction. Moreover, the metallic calcium is preferably added in an amount that is 1.1 to 3.0 times, more preferably 1.5 to 2.5 times the reaction equivalent, which is the stoichiometric amount needed to reduce the rare earth oxide(s), and includes the amount needed to reduce an oxide of the Fe component, if present.

In the reduction step, a disintegration accelerator may optionally be used together with the reducing agent metallic calcium. The disintegration accelerator may be appropriately used to facilitate the disintegration or granulation of the product during the post treatment step described later. Examples include alkaline earth metal salts such as calcium chloride and alkaline earth oxides such as calcium oxide. Such a disintegration accelerator may be used in an amount of at least 1% by mass but not more than 30% by mass, preferably at least 5% by mass but not more than 30% by mass, relative to the amount of the samarium oxide.

### Nitridation Step

The nitridation step includes nitriding the alloy particles obtained in the reduction step to obtain anisotropic magnetic particles. As the particulate precipitate obtained in the precipitation step is used, the alloy particles obtained in the reduction step are in porous bulk form. This permits the alloy particles to be directly nitrided by heat treatment in a nitrogen atmosphere without grinding, resulting in uniform nitridation.

The heat treatment temperature in the nitridation of the alloy particles (hereinafter, nitridation temperature) is preferably 300° C. to 610° C., particularly preferably 400° C. to 550° C., and the atmosphere may be replaced with nitrogen to perform the heat treatment in this temperature range. The heat treatment duration may be selected so that the alloy particles can be sufficiently uniformly nitrided.

With regard to the heat treatment temperature in the nitridation of the alloy particles, heat treatment for nitridation may be performed at a first temperature of at least 400° C. but not higher than 470° C. and then at a second temperature of at least 480° C. but not higher than 610° C. If the alloy particles are heat-treated at the high second temperature without being nitrided at the first temperature, the nitridation may rapidly proceed to cause abnormal heat generation which can degrade the SmFeN-based anisotropic magnetic powder, greatly reducing the magnetic properties. Moreover, the nitridation step is preferably performed in a substantially nitrogen-containing atmosphere in order to allow the nitridation to proceed more slowly.

Here, the term “substantially” is used in consideration of the potential presence of unavoidable element(s) other than nitrogen due to contamination of impurities or other factors. For example, the nitrogen content of the atmosphere is not lower than 95%, preferably not lower than 97%, more preferably not lower than 99%.

The first temperature in the nitridation step is preferably at least 400° C. but not higher than 470° C., more preferably at least 410° C. but not higher than 450° C. If the first temperature is lower than 400° C., the nitridation tends to proceed very slowly. If the first temperature is higher than 470° C., excessive nitridation or degradation tends to easily occur due to heat generation. The heat treatment duration at the first temperature is not limited, but is preferably at least one hour but not longer than 40 hours, more preferably not longer than 20 hours. If the heat treatment duration is shorter than one hour, the nitridation may insufficiently proceed. If the heat treatment duration is longer than 40 hours, productivity is impaired.

The second temperature is preferably at least 480° C. but not higher than 610° C., more preferably at least 500° C. but not higher than 550° C. If the second temperature is lower than 480° C., the nitridation of large particles may insufficiently proceed. If the second temperature is higher than 610° C., excessive nitridation or degradation can easily occur. The heat treatment duration at the second temperature is preferably at least 15 minutes but not longer than 5 hours, more preferably at least 30 minutes but not longer than 2 hours. If the heat treatment duration is shorter than 15 minutes, the nitridation may insufficiently proceed. If the heat treatment duration is longer than 5 hours, productivity is impaired.

The heat treatment at the first temperature and the heat treatment at the second temperature may be continuously performed. Although there may be a heat treatment at a temperature lower than the second temperature between these heat treatments, it is preferred in view of productivity to perform these heat treatments continuously.

### Washing Step

The method may include washing the nitride obtained after the nitridation step to obtain a SmFeN-based anisotropic magnetic powder. The product obtained after the nitridation step may contain, in addition to the magnetic particles, materials such as by-product CaO and unreacted metallic calcium, which may be combined into sintered bulk form. The product obtained after the nitridation step may be introduced into cold water to separate the CaO and metallic calcium as a suspension of calcium hydroxide (Ca(OH)₂) from the SmFeN-based anisotropic magnetic powder. Further, the residual calcium hydroxide may be sufficiently removed by washing the SmFeN-based anisotropic magnetic powder with acetic acid or the like. When the product is introduced into water, oxidation of metallic calcium by water and hydration of by-product CaO will occur, causing disintegration, i.e., micronization, of the reaction product that has been combined into sintered bulk form.

### Alkali Treatment Step

The product obtained after the nitridation step may be introduced into an alkali solution. Examples of the alkali solution used in the alkali treatment step include an aqueous calcium hydroxide solution, an aqueous sodium hydroxide solution, and an aqueous ammonia solution. In view of wastewater treatment and high pH, an aqueous calcium hydroxide solution or an aqueous sodium hydroxide solution is preferred among these. In the alkali treatment of the product obtained after the nitridation step, the remaining Sm-rich layer containing a certain amount of oxygen serves as a protection layer, thereby reducing an increase in oxygen concentration caused by the alkali treatment.

The pH of the alkali solution used in the alkali treatment step is not limited, but is preferably not less than 9, more preferably not less than 10. If the pH is less than 9, the rate of the reaction into calcium hydroxide is higher, causing greater heat generation. Thus, the finally produced SmFeN-based anisotropic magnetic powder tends to have a higher oxygen concentration.

In the alkali treatment step, the SmFeN-based anisotropic magnetic powder obtained after the treatment with the alkali solution may optionally be subjected to decantation or other techniques to reduce the moisture. An acid treatment step using an acid solution may be performed in place of the alkali treatment step, or alternatively both steps may be performed together.

### Dehydration Step

The washing step or the alkali treatment step may be followed by dehydration. The dehydration can reduce the moisture in the solids before vacuum drying, thereby inhibiting the progress of oxidation during drying caused due to the higher moisture content of the solids before vacuum drying. Herein, the term “dehydration” refers to a treatment in which a pressure or a centrifugal force is applied to reduce the moisture content of the solids after the treatment as compared to that of the solids before the treatment, and excludes mere decantation, filtration, or drying. The dehydration may be performed by any method such as squeezing or centrifugation.

The moisture content of the SmFeN-based anisotropic magnetic powder after the dehydration is not limited. In order to inhibit the progress of oxidation, it is preferably not more than 13% by mass, more preferably not more than 10% by mass.

The SmFeN-based anisotropic magnetic powder obtained by the acid treatment or the SmFeN-based anisotropic magnetic powder obtained by the acid treatment and subsequent dehydration is preferably dried under vacuum. The drying temperature is not limited, but is preferably not lower than 70° C., more preferably not lower than 75° C.

The drying duration is also not limited, but it is preferably not shorter than one hour, more preferably not shorter than three hours.

### Dispersion Step

The washing step may be followed by dispersing the SmFeN-based anisotropic magnetic powder. The dispersion in the dispersion step may be performed as described for the dispersion method in the mixing step. Specifically, the SmFeN-based anisotropic magnetic powder may be dispersed using resin-coated metal media or resin-coated ceramic media. When the alkali treatment step and/or the dehydration step is performed, the dispersion step is performed after these steps.

The SmFeN-based rare earth magnet prepared by the method of producing a SmFeN-based rare earth magnet according to the present embodiments is typically represented by the following general formula:

SmᵥFe_{(100-v-w-x-y-z-u)}N_{w}LaₓW_{y}Ti_{z}

wherein 3≤v≤30, 5≤w≤15, 0≤x≤0.3, 0≤y≤2.5, and 0≤z≤2.5.

In the general formula, v is defined to be at least 3 but not more than 30 for the following reason. If v is less than 3, the unreacted iron component (α-Fe phase) may be separated, reducing the coercive force of the SmFeN-based anisotropic magnetic powder and making the magnet impractical, while if v is more than 30, the Sm element may precipitate and make the SmFeN-based anisotropic magnetic powder unstable in the air, thereby reducing the remanence. Moreover, w is defined to be at least 5 but not more than 15 for the following reason. If w is less than 5, almost no coercive force may be obtained, while if w is more than 15, a nitride of Sm or iron itself may be formed.

In particular, SmFeN, SmFeLaN, SmFeLaWN, SmFeLaWRN, and SmFeLaWTiN are preferred.

In view of remanence, the amount of La, if present, is preferably at least 0.1% by mass but not more than 5% by mass, more preferably at least 0.15% by mass but not more than 1% by mass.

In view of coercive force and squareness ratio, the amount of W, if present, is preferably at least 0.1% by mass but not more than 5% by mass, more preferably at least 0.15% by mass but not more than 1% by mass.

In view of temperature characteristics, the amount of R which is at least one selected from the group consisting of Ti, Ba, and Sr, if present, is preferably at least 0.1% by mass but not more than 5% by mass, more preferably at least 0.15% by mass but not more than 1% by mass.

The amount of N is preferably at least 3.3% by mass but not more than 3.5% by mass. If the amount is more than 3.5% by mass, excessive nitridation may occur. If the amount is less than 3.3% by mass, insufficient nitridation may occur. In both cases, the magnetic properties tend to decrease.

The density of the SmFeN-based rare earth magnet prepared by the method of producing a SmFeN-based rare earth magnet according to the present embodiments is not limited, but it is preferably at least 5.8 g/cm 3 but not more than 7 g/cm 3, more preferably at least 6 g/cm 3 but not more than 6.7 g/cm 3.

A SmFeN-based rare earth magnet according to embodiments of the present disclosure includes:
a SmFeN-based anisotropic magnetic powder; and
a coating portion coating the SmFeN-based anisotropic magnetic powder,
wherein the coating portion includes an outer peripheral region in which P is localized, and an inner region located inward from the outer peripheral region, in which Zn is localized.

The SmFeN-based rare earth magnet can be produced by, for example, the method of producing a SmFeN-based rare earth magnet according to the embodiments described above. As described in paragraph [0013], by heat-treating a magnetic powder at a low temperature of at least 80° C. but lower than 150° C. after the formation of a phosphate coating on the magnetic powder, the phosphate film can be prevented from excessively coating the surface of the magnetic powder particles, and during sintering, Zn can diffuse into the magnetic powder and a fluidized bed can be formed. As a result, the SmFeN-based anisotropic magnetic powder in the SmFeN-based rare earth magnet according to the present embodiments has a unique structure as shown in the schematic diagram of the attached FIGURE. In a coating portion 20, an inner region 22 in which Zn is localized is provided inward from an outer peripheral region 21 in which P is localized. The resulting SmFeN-based rare earth magnet exhibits a high remanence Br and a high coercive force iHc.

The average particle size of the SmFeN-based anisotropic magnetic powder in the SmFeN-based rare earth magnet is not limited, but is preferably at least 0.5 μm but not more than 5 μm, more preferably at least 2.5 μm but not more than 3.5 μm. The thickness of the coating portion is preferably at least 1 nm but not more than 50 nm, more preferably at least 5 nm but not more than 30 nm. The thickness of the outer peripheral region in which P is localized is preferably at least 0.5 nm but not more than nm, more preferably at least 1 nm but not more than 5 nm. The thickness of the inner region in which Zn is localized is preferably at least 0.5 nm but not more than 10 nm, more preferably at least 0.5 nm but not more than 5 nm.

### EXAMPLES

Examples are described below. It should be noted that “%” is by mass unless otherwise specified.

Evaluation

The D₅₀, residual magnetization ar, remanence Br, coercive force iHc, and Hk, and BHmax of the SmFeN-based anisotropic magnetic powder, and the density of the SmFeN-based magnet were evaluated as follows.

### D₅₀

The average particle size and particle size distribution of the SmFeN-based anisotropic magnetic powder were measured with a laser diffraction particle size distribution analyzer (HELOS & RODOS available from Japan Laser Corporation).

Residual Magnetization σr, Remanence Br, Coercive Force iHc, Squareness Ratio Hk, and Maximum Energy Product BHmax

The prepared SmFeN-based rare earth magnetic powder was packed together with a paraffin wax into a sample vessel. After the paraffin wax was melted using a dryer, the easy axes of magnetization were aligned in an orientation field of 16 kA/m. The magnetically oriented sample was pulse-magnetized in a magnetizing field of 32 kA/m, and the residual magnetization ar, coercive force iHc, squareness ratio Hk, and maximum energy product BHmax of the sample were measured using a vibrating sample magnetometer (VSM) with a maximum field of 16 kA/m. Here, the remanence Br (unit: T) was calculated from the residual magnetization σr (unit: emu/g) using the equation: Br=4×π×ρ×σr, where ρ represents the density and is 7.66 g/cm³.

### Density of Sintered Magnet

The mass and external dimensions of the sintered magnet were measured. An estimated volume was calculated from the external dimensions. The mass was divided by the estimated volume, and the quotient was taken as the density of the sintered magnet.

### Production Example 1

### SmFeLaWTi-Based Magnetic Powder

### Precipitation Step

An amount of 5.0 kg of FeSO₄·7H₂O was mixed and dissolved in 2.0 kg of pure water. To the mixture were further added 0.49 kg of Sm₂O₃, 0.035 kg of La₂O₃, 0.006 kg of titanium oxide, and 0.74 kg of 70% sulfuric acid, and they were well stirred and completely dissolved. Next, pure water was added to the resulting solution so that the final Fe and Sm concentrations were adjusted to 0.726 mol/L and 0.112 mol/L, respectively, to obtain a SmFeLaTi sulfuric acid solution.

The entire amount of the prepared SmFeLaTi sulfuric acid solution was added dropwise to 20 kg of pure water kept at a temperature of 60° C. with stifling over 70 minutes from the start of the reaction, while simultaneously adding dropwise 0.190 kg of a 13% by mass ammonium tungstate solution and a 15% by mass ammonia solution to adjust the pH to 7 to 8. Thus, a slurry containing a SmFeLaWTi hydroxide was obtained. The slurry was washed with pure water by decantation, followed by solid-liquid separation to separate the hydroxide. The separated hydroxide was dried in an oven at 100° C. for 10 hours.

### Oxidation Step

The hydroxide obtained in the precipitation step was calcined in the air at 1000° C. for one hour. After cooling, a red SmFeLaWTi oxide was obtained as a raw material powder.

### Pretreatment Step

An amount of 100 g of the SmFeLaWTi oxide was put in a steel container to a thickness of 10 mm. The container was placed in a furnace, and the pressure was reduced to 100 Pa. Then, while introducing hydrogen gas, the temperature was increased to 850° C. and maintained at this temperature for 15 hours.

### Reduction Step

An amount of 60 g of the partial oxide obtained in the pretreatment step was mixed with 19.2 g of metallic calcium having an average particle size of about 6 mm, and the mixture was placed in a furnace. After vacuum evacuation of the furnace, argon gas (Ar gas) was introduced into the furnace. The temperature was increased to 1060° C. and maintained for 45 minutes to obtain SmFeLaWTi alloy particles.

### Nitridation Step

Subsequently, the temperature inside the furnace was lowered to 100° C., followed by vacuum evacuation. Then, while introducing nitrogen gas, the temperature was increased to a first temperature of 430° C. and maintained for three hours. Next, the temperature was increased to a second temperature of 520° C. and maintained for one hour, followed by cooling to obtain a magnetic particle-containing bulk product.

### Washing Step

The bulk product obtained in the nitridation step was introduced into 3 kg of pure water and stirred for 30 minutes. After standing still, the supernatant was drained by decantation. The introduction into pure water, stirring, and decantation were repeated 10 times. Next, 2.5 g of 99.9% acetic acid was introduced and stirred for 15 minutes. After standing still, the supernatant was drained by decantation. The introduction into pure water, stirring, and decantation were repeated twice. Next, 120 g of 6% hydrochloric acid was introduced and stirred until the pH reached 5. After standing still, the supernatant was drained by decantation. The introduction into pure water, stirring, and decantation were repeated twice. After solid-liquid separation, the product was subjected to vacuum drying (heat treatment) at 90° C. for three hours to obtain a SmFeN-based anisotropic magnetic powder.

### Dispersion Step

The obtained SmFeN-based anisotropic magnetic powder and media (nylon-coated iron core media, diameter: 10 mm, Vickers number of nylon coating: 7, specific gravity: 7.48, thickness of nylon layer: about 1 to 3 mm) were put into a container used in a vibration mill so that the amounts of the SmFeN-based anisotropic magnetic powder and the media were 5% by volume and 60% by volume, respectively, relative to the volume of the container. The powder was dispersed by the vibration mill in a nitrogen atmosphere for 30 minutes to obtain a SmFeN-based anisotropic magnetic powder.

### Acid Treatment Step

The obtained SmFeN-based anisotropic magnetic powder in an amount of 250 g was introduced into 3 L of stirred pure water to prepare a slurry, and 200 g of 6% hydrochloric acid was introduced into the slurry. The resulting slurry was stirred to remove the oxidized surface film and contaminants, followed by repeating draining and filling of water.

### Phosphate Source Treatment Step

A phosphoric acid solution was added to the slurry obtained in the acid treatment step. The phosphoric acid solution was introduced in an amount corresponding to 1 wt % of PO₄ relative to the solids content of the magnetic particles. The mixture was stirred for five minutes and then subjected to solid-liquid separation, followed by vacuum drying (heat treatment) at 120° C. for three hours to obtain a SmFeLaWTi-based magnetic powder.

### Production Example 2

### SmFeLaW-Based Magnetic Powder

A SmFeLaW-based magnetic powder was obtained as in Production Example 1, except that in the precipitation step, no titanium oxide was used and the amount of the ammonium tungstate solution was changed to 0.760 kg.

### Comparative Production Example 1

### SmFeLaWTi-Based Magnetic Powder

A SmFeLaWTi-based magnetic powder was obtained as in Production Example 1, except that the vacuum drying temperature in the phosphate source treatment step was changed from 120° C. to 190° C.

### Comparative Production Example 2

### SmFeLaW-Based Magnetic Powder

A SmFeLaW-based magnetic powder was obtained as in Production Example 1, except that in the precipitation step, no titanium oxide was used and the amount of the ammonium tungstate solution was changed to 0.760 kg, and the vacuum drying temperature in the phosphate source treatment step was changed from 120° C. to 190° C.

The D₅₀, residual magnetization ar, coercive force iHc, and squareness ratio Hk of the magnetic powders prepared in Production Examples 1 and 2 and Comparative Production Examples 1 and 2 were measured as described above. Table 1 shows the measurement results.

TABLE 1

| | Drying | | Magnetic properties | | |
|---|---|---|---|---|---|
| Production | temperature | | σr | iHc | Hk |
| Example No. | (° C.) | D50 | (emu/g) | (Oe) | (Oe) |
| Production | 120 | 2.72 | 146.5 | 13330 | 5725 |
| Example 1 | | | | | |
| Production | 120 | 1.37 | 135.4 | 16060 | 7961 |
| Example 2 | | | | | |
| Comparative | 190 | 2.56 | 146.0 | 17720 | 10950 |
| Production | | | | | |
| Example 1 | | | | | |
| Comparative | 190 | 1.33 | 131.3 | 25594 | 13400 |
| Production | | | | | |
| Example 2 | | | | | |

### Production Examples 3 to 6 and Comparative Production Examples 3 to 6

### Modifier Powder Mixing Step

The magnetic powders prepared in Production Examples 1 and 2 and Comparative Production Examples 1 and 2 and a metallic zinc powder (D₅₀: 0.5 μm, purity: 99.9% by mass) were dispersed and mixed at the mixing ratio shown in Table 2 in a vibration mill to prepare a powder mixture. The dispersion and mixing in the vibration mill were carried out using nylon-coated iron core media (diameter: 10 mm, Vickers number of nylon coating: 7, specific gravity: 7.48, thickness of nylon layer: about 1 to 3 mm) in a nitrogen atmosphere. The residual magnetization ar, coercive force iHc, and squareness ratio Hk of each resulting magnetic powder mixture were measured as described above. Table 2 shows the measurement results.

TABLE 2

| | Amount | Phosphate-coated | Mixing | Phosphate-coated | Mixing | | | |
|---|---|---|---|---|---|---|---|---|
| Production | of Zn | magnetic | ratio | magnetic | ratio | σr | iHc | Hk |
| Example No. | added (%) | particles | (%) | particles | (%) | (emu/g) | (Oe) | (Oe) |
| Production | 5 | Production | 82.65 | Production | 12.35 | 141.5 | 13480 | 6614 |
| Example 3 | | Example 1 | | Example 2 | | | | |
| Production | 6 | Production | 81.78 | Production | 12.22 | 140.2 | 13460 | 6565 |
| Example 4 | | Example 1 | | Example 2 | | | | |
| Production | 7 | Production | 80.91 | Production | 12.09 | 139.3 | 13440 | 6569 |
| Example 5 | | Example 1 | | Example 2 | | | | |
| Production | 8 | Production | 80.04 | Production | 11.96 | 137.5 | 13510 | 6619 |
| Example 6 | | Example 1 | | Example 2 | | | | |
| Comparative | 5 | Comparative | 82.65 | Comparative | 12.35 | 136.7 | 17940 | 10120 |
| Production | | Production | | Production | | | | |
| Example 3 | | Example 1 | | Example 2 | | | | |
| Comparative | 6 | Comparative | 81.78 | Comparative | 12.22 | 133.0 | 17210 | 9478 |
| Production | | Production | | Production | | | | |
| Example 4 | | Example 1 | | Example 2 | | | | |
| Comparative | 7 | Comparative | 80.91 | Comparative | 12.09 | 135.1 | 17990 | 10150 |
| Production | | Production | | Production | | | | |
| Example 5 | | Example 1 | | Example 2 | | | | |
| Comparative | 8 | Comparative | 80.04 | Comparative | 11.96 | 132.7 | 17970 | 10080 |
| Production | | Production | | Production | | | | |
| Example 6 | | Example 1 | | Example 2 | | | | |

### Examples 1 to 4 and Comparative Examples 1 to 4

### Compaction Step

Each of the powder mixtures prepared in Production Examples 3 to 6 and Comparative Production Examples 3 to 6 was compacted in a magnetic field to obtain a magnetic field compact. The compaction pressure was 200 MPa and the magnetic field applied was 2T.

### Sintering Step

The magnetic field compact was pressure-sintered to obtain a sintered compact. The pressure-sintering (spark plasma sintering, SPS) was carried out under vacuum at a sintering temperature of 380° C., an applied pressure of 550 MPa, and an application duration of 30 minutes.

### Heat Treatment Step

The sintered compact was heat-treated to obtain a SmFeN-based rare earth magnet of Example 1. The heat treatment was carried out in a vacuum atmosphere at a heat treatment temperature of 380° C. and a heat treatment duration of 24 hours.

The density, remanence Br, coercive force iHc, squareness ratio Hk, and BHmax of the SmFeN-based rare earth magnets obtained in Examples 1 to 4 and Comparative Examples 1 to 4 were measured as described above. Table 3 shows the measurement results.

TABLE 3

| | | Compaction step | | | | | | | | | | |
|---|---|---|---|---|---|---|---|---|---|---|---|---|
| | | Pressing | Orientation | Sintering step | | | | SmFeN-based rare earth magnet | | | | |
| | Magnetic | pressure | field | Pressure | Temperature | Duration | | Density | Br | iHc | Hk | |
| Example No. | powder | (MPa) | (T) | (MPa) | (° C.) | (min) | Atmosphere | (g/cm³) | (T) | (kOe) | (kOe) | BHmax |
| Example 1 | Production | 200 | 2 | 550 | 380 | 30 | vacuum | 6.17 | 1.01 | 13.66 | 6.72 | 23.66 |
| | Example 3 | | | | | | | | | | | |
| Example 2 | Production | 200 | 2 | 550 | 380 | 30 | vacuum | 6.32 | 1.00 | 13.79 | 6.90 | 23.26 |
| | Example 4 | | | | | | | | | | | |
| Example 3 | Production | 200 | 2 | 550 | 380 | 30 | vacuum | 6.18 | 1.00 | 12.44 | 5.45 | 22.36 |
| | Example 5 | | | | | | | | | | | |
| Example 4 | Production | 200 | 2 | 550 | 380 | 30 | vacuum | 6.34 | 1.01 | 14.21 | 6.23 | 23.42 |
| | Example 6 | | | | | | | | | | | |
| Comparative | Comparative | 200 | 2 | 550 | 380 | 30 | vacuum | 5.97 | 0.99 | 9.80 | 5.21 | 21.76 |
| Example 1 | Production | | | | | | | | | | | |
| | Example 3 | | | | | | | | | | | |
| Comparative | Comparative | 200 | 2 | 550 | 380 | 30 | vacuum | 6.03 | 0.97 | 10.75 | 5.53 | 21.28 |
| Example 2 | Production | | | | | | | | | | | |
| | Example 4 | | | | | | | | | | | |
| Comparative | Comparative | 200 | 2 | 550 | 380 | 30 | vacuum | 6.42 | 0.97 | 13.00 | 7.14 | 21.92 |
| Example 3 | Production | | | | | | | | | | | |
| | Example 5 | | | | | | | | | | | |
| Comparative | Comparative | 200 | 2 | 550 | 380 | 30 | vacuum | 6.30 | 0.99 | 12.57 | 6.39 | 22.83 |
| Example 4 | Production | | | | | | | | | | | |
| | Example 6 | | | | | | | | | | | |

The results in Table 3 show that sintered magnets with excellent magnetic properties were obtained in Examples 1 to 4 using a magnetic powder prepared by heat-treating a SmFeN-based anisotropic magnetic powder having a surface coated with a phosphate at 120° C., as compared to Comparative Examples 1 to 4 using a magnetic powder heat-treated at 190° C.

What is claimed is:

1. A method of producing a SmFeN-based rare earth magnet, the method comprising:
heat-treating a SmFeN-based anisotropic magnetic powder having a surface coated with a phosphate at a temperature of at least 80° C. but lower than 150° C.;
mixing the heat-treated SmFeN-based anisotropic magnetic powder and a Zn-containing modifier powder by dispersion using resin-coated metal media or resin-coated ceramic media to obtain a powder mixture containing the SmFeN-based anisotropic magnetic powder and the modifier powder;
compacting the powder mixture in a magnetic field to obtain a magnetic field compact; and
pressure-sintering the magnetic field compact to obtain a sintered compact.

2. The method of producing a SmFeN-based rare earth magnet according to claim 1, further comprising, before the heat-treating:
acid-treating the SmFeN-based anisotropic magnetic powder to be used in the heat-treating with an acid to obtain an acid-treated SmFeN-based anisotropic magnetic powder, and
phosphate-source-treating the acid-treated SmFeN-based anisotropic magnetic powder with a phosphate source to obtain the SmFeN-based anisotropic magnetic powder having the surface coated with the phosphate.

3. The method of producing a SmFeN-based rare earth magnet according to claim 1,
wherein in the mixing, the dispersion is performed in a dry condition.

4. The method of producing a SmFeN-based rare earth magnet according to claim 1,
wherein the resin-coated metal media or the resin-coated ceramic media have a specific gravity of at least 4.

5. The method of producing a SmFeN-based rare earth magnet according to claim 1,
wherein the heat-treated SmFeN-based anisotropic magnetic powder includes a first particle group and a second particle group, and
the first particle group has a particle size D₅₀ at 50% of a cumulative particle size distribution by volume that is larger than a particle size D₅₀ at 50% of a cumulative particle size distribution by volume of the second particle group.

6. The method of producing a SmFeN-based rare earth magnet according to claim 1,
wherein the SmFeN-based anisotropic magnetic powder comprises La, W, and R, wherein R is at least one selected from the group consisting of Ti, Ba, and Sr.

7. The method of producing a SmFeN-based rare earth magnet according to claim 6, further comprising:
pretreating an oxide containing Sm, Fe, La, W, and R, wherein R is at least one selected from the group consisting of Ti, Ba, and Sr, by heat treatment in a reducing-gas-containing atmosphere to obtain a partial oxide;
reducing the partial oxide by heat treatment in the presence of a reducing agent to obtain alloy particles;
nitriding the alloy particles to obtain a nitride; and
washing the nitride to obtain the SmFeN-based anisotropic magnetic powder to be used in the heat-treating.

8. The method of producing a SmFeN-based rare earth magnet according to claim 1, further comprising
heat-treating the sintered compact to obtain a SmFeN-based rare earth magnet.

9. A SmFeN-based rare earth magnet, comprising:
a SmFeN-based anisotropic magnetic powder; and
a coating portion coating the SmFeN-based anisotropic magnetic powder,
the coating portion comprising an outer peripheral region in which P is localized, and an inner region located inward from the outer peripheral region, in which Zn is localized.
